(19) United States
(12) Patent Application Publication
(10) Pub. No.: US 2022/0053792 A1
(43) Pub. Date: Feb. 24, 2022

(54) FOOD COMPOSITION CONTAINING A MIXTURE OF LEGUMINOUS PROTEINS AND CASEIN

(71) Applicant: ROQUETTE FRERES, Lestrem (FR)

(72) Inventors: Goichi ITO, Tokyo (JP); Sayaka MINOURA, Tokyo (JP); Ayana SATO, Tokyo (JP)

(21) Appl. No.: 17/277,134

(22) PCT Filed: Sep. 25, 2019
(86) PCT No.: PCT/EP2019/075835

§ 371 Date: Mar. 17, 2021

(30) Foreign Application Priority Data
Sep. 25, 2018 (EP) 18306249.6

(51) Int. Cl. A23J 1/20; A23J 1/14; A23J 3/10; A23J 3/14; A23L 33/185; A23L 33/19

(52) U.S. Cl. CPC A23J 1/202; A23J 1/14; A23L 33/19; A23J 3/14; A23L 33/185; A23J 3/10

(57) ABSTRACT

The invention relates to an arginine-rich food composition comprising 10-20% by weight of proteins based on the weight of the composition and having a low hardness, as measured with Test A defined herein, of 0.01 to 0.2 N, to its preparation process by mixing a leguminous protein source and a casein source, and also to the uses thereof, in particular in the food-processing field and most particularly the preparation of food formulations. The food composition preferably comprises a mixture of a leguminous protein source and a casein source. The leguminous protein source is preferably pea protein isolate.

### FIELD OF THE INVENTION

The invention relates to an arginine-rich food composition comprising proteins and having a low hardness, to its preparation process by mixing a leguminous protein source and a casein source, and also to the uses thereof, in particular in the food-processing field and most particularly the preparation of food formulations.

### TECHNICAL BACKGROUND

Along with carbohydrates and lipids, proteins constitute a considerable part of our diet. Generally, consumed proteins are either of animal origin (referred to as animal proteins), such as meat, fish, eggs and dairy products, or of plant origin (referred to as plant proteins), such as cereals and leguminous plants.

Their nutritional role is to provide amino acids and energy, which are substrates required for the synthesis of the body's proteins.

Proteins consist of a sequence of amino acids. There are 20 amino acids, 9 of which are essential to humans since the body is not able to synthesize them and must therefore be provided by the diet.

In the conventional approach, the quality of proteins is evaluated on the basis of their essential amino acid content. As a general rule, proteins of animal origin are richer in certain essential amino acids like lysine than plant proteins but milk proteins are poorer in arginine.

Leguminous proteins, especially pea and fava bean, contain a high percentage of arginine compared to other protein sources such as soy and milk, which makes it a good choice for applications requiring high level of arginine, such as nursing food formulations and ulcer fighting formulations (see WO 99/58000), or also sarcopenia fighting formulations. Such formulations are obtained with processes that often comprise a series of heating and cooling steps so as to control the level of microorganisms therein.

Unfortunately, when pea protein is heated, it may develop higher viscosity after cooling and lead to a product which is not suited for some consumers like elderly people which require more liquid formulation. Heating and cooling steps lead to a gel structure, which can sometimes be quite hard.

A solution to lower the hard texture may be to hydrolyze the pea proteins but this leads to more bitter flavors and less nutritive proteins. The process to obtain such formulations is also more complex and costly.

Thus, there is still a technical need for a pea based food composition, rich in arginine, which has a relatively low hardness and stays liquid after sterilization and cooling step.

### SUMMARY OF THE INVENTION

A first object of the present invention is a food composition comprising 10% to 20%, preferably 15 to 20%, by weight of proteins based on the weight of the composition, wherein said composition exhibits a hardness, as measured with Test A defined herein, of 0.01 to 0.2 N, preferably 0.1 to 0.2 N.

A second object of the present invention is a process for preparing the food composition of the invention, said process comprising the steps of:
providing a composition comprising water, a leguminous protein source, preferably a pea protein isolate, and a casein source, preferably a milk protein concentrate, in a weight ratio of leguminous protein source to casein source of 50/50 to 85/15, in particular 60/40 to 80/20;
optionally mixing the composition until full homogenization;
optionally introducing the composition in a package;
heat-sterilizing the composition.

A third object of the present invention is the use of the food composition of the invention or obtainable with the process of the invention in the preparation of a food formulation, such as a specialized nutrition composition or a feed composition.

### DETAILED DESCRIPTION OF THE INVENTION

For the purposes of the present invention, the term “food composition” or “food formulation” is intended to mean a composition that can be ingested by an animal or a human being. Examples of food compositions include foodstuffs for human consumption, animal feed and beverages.

The food composition of the invention exhibits a hardness, as measured with Test A defined herein, of 0.01 to 0.2 N, preferably 0.1 to 0.2 N.

The food composition of the invention comprises 10% to 20%, preferably 11 to 20%, 12 to 20%, 13 to 20%, 14 to 20%, even more preferably 15 to 20% by weight of proteins based on the weight of the composition.

For the purposes of the present invention, the term “protein” is intended to mean mono or polychains of polypeptidic macromolecules constituted by a succession of aminoacids linked by peptidic bonds. In the invention, the term “protein” encompasses proteins obtained from leguminous plants like fava bean or pea and casein.

Any reference assay method for quantifying the level of protein well known to one skilled in the art can be used. Preferably, a determination of the total nitrogen (in %/crude) is carried out and the result is multiplied by the coefficient 6.25. This well-known methodology in the field of proteins is based on the observation that proteins contain on average 16% of nitrogen.

In one embodiment, the food composition of the invention comprises a mixture of a leguminous protein source and a casein source.

In the context of the invention, the term “casein” is intended to mean a family of related phosphoproteins (αS1, αS2, β, κ). These proteins are commonly found in mammalian milk. For example, cow's milk comprises about 80% by weight of proteins and human milk comprises about 20% to 45% by weight of proteins. In the context of the present invention, the term “casein source” is intended to mean a composition comprising casein. The casein source may be derived from cows but also from other animals like goats. The most common form of casein is sodium caseinate but others forms exist like potassium caseinate or a milk protein concentrate (MPC).

In a preferred embodiment, the casein source may be selected from a milk protein concentrate, calcium caseinate, sodium caseinate, magnesium caseinate, potassium caseinate and mixtures thereof. More preferably, the casein source may be a milk protein concentrate.

In the context of the present invention, the term “leguminous plants” is intended to mean any plant belonging to the families Caesalpiniaceae, Mimosaceae or Papilionaceae, such as alfalfa, clover, lupin, pea, bean, broad bean, horse bean or lentil, and more particularly pea. The term “leguminous proteins” is intended to mean proteins that are derived from a leguminous plant, for example by extraction and optionally further modification. The term “leguminous protein source” is intended to mean a composition comprising leguminous proteins, such as a leguminous protein isolate or concentrate.

In a preferred embodiment, the leguminous protein source may be a pea protein isolate, a pea protein concentrate, a fava bean protein isolate, a fava bean protein concentrate, and mixtures thereof. More preferably, the leguminous protein source may be a pea protein isolate.

A suitable pea protein isolate or concentrate can be extracted from peas with common and available processes known by man skilled in the art. Pea protein isolates obtained by wet processes, such as those disclosed in EP1400537, are particularly preferred.

The term “pea” is herein considered in its broadest accepted sense and includes in particular:
all varieties of “smooth pea” and of “wrinkled pea”, and
all mutant varieties of “smooth pea” and of “wrinkled pea”, this being whatever the uses for which said varieties are generally intended (food for human consumption, animal feed and/or other uses).

In the present application, the term “pea” includes the varieties of pea belonging to the Pisum genus, more particularly Pisum sativum.

The mutant varieties are in particular those known as “r mutants”, “rb mutants”, “rug 3 mutants”, “rug 4 mutants”, “rug 5 mutants” and “lam mutants” as described in the article by C-L HEYDLEY et al. entitled “Developing novel pea starches”, Proceedings of the Symposium 10 of the Industrial Biochemistry and Biotechnology Group of the Biochemical Society, 1996, pp. 77-87.

In a preferred embodiment, said leguminous protein is derived from smooth pea.

Peas are leguminous plants with protein-rich seeds which have been widely developed in Europe and in France, not only as a protein source for animal feed, but also as food for human consumption.

Like all leguminous plant proteins, pea proteins consist of three main classes of proteins: globulins (about 50-60% by weight of the pea proteins), albumins (about 20-25% by weight of the pea proteins) and “insoluble” proteins. Further, pea globulins can be classified in three families: legumins, vicilins and convicilins.

The value of pea proteins lies in their good emulsifying capacities, their lack of allergenicity and their low cost, which makes them an economical functional ingredient.

Furthermore, pea proteins favourably contribute to sustainable development and their carbon impact is very positive. This is because pea cultivation is environmentally friendly and does not require nitrogenous fertilizers, since the pea fixes atmospheric nitrogen.

In one embodiment, the food composition of the present invention exhibits a weight ratio of the leguminous protein source to the casein source of 50/50 to 85/15, more particularly 60/40 to 80/20.

The food composition of the invention may have an amount of leguminous proteins sufficient to qualify as an arginine-rich food composition according to the relevant nutritional requirements. For example, according to the Guideline of JASPEN (Japanese Society for Parenteral & Enteral Nutrition), the recommended amount of arginine for people who suffer from pressure ulcers should be of 7.5 g/day. The average content of arginine in a pea protein isolate is around 6.5% by weight of total protein content. In an 85% protein rich isolate, arginine represents 5.5 g per 100 g of isolate. In comparison, the average content of arginine in a milk protein concentrate is around 3% by weight of the total weight of proteins.

In the context of the present invention, the term “arginine” is intended to mean an amino-acid represented by the following formula. The amount of said amino-acid in leguminous proteins, in particular in pea proteins, is relatively high.

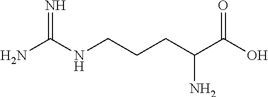 [SMILES: N=C(N)NCCCC(N)C(=O)O]

In one embodiment, the food composition of the present invention comprises 0.4% to 1.4%, in particular 0.5% to 1.3%, more particularly 0.6% to 1.2%, by weight of arginine based on the weight of the composition.

The food composition of the invention may further comprise additives, such as flavors, stabilizers, gelling agents, emulsifiers, sweeteners, soluble fibers, insoluble fibers, starch, dextrin or polyols.

In one embodiment, the food composition of the invention further comprises maltodextrine, preferably 16 to 20% by weight of maltodextrine based on the total weight of the composition, even more preferably about 16%, 17%, 18%, 18.5%, 18.8%, 19% or 20% by weight of maltodextrine based on the total weight of the composition.

In one embodiment, the food composition of the invention further comprises oil, typically sunflower oil. In one embodiment, the food composition of the invention further comprises 1 to 5% by weight of sunflower oil based on the total weight of the composition, even more preferably about 2, 2.1, 2.2, 2.3, 2.4, 2.5, 2.6, 2.7, 2.8, 2.9 or 3% by weight of sunflower oil based on the total weight of the composition.

The food composition of the invention can be obtained with the process according to the invention described below.

All of the examples and preferential embodiments described for the food composition of the invention equally apply to the process of the present invention.

The process of the invention comprises a step of providing a composition comprising water, a leguminous protein source and a casein source.

The leguminous protein source and the casein source are mixed together in a weight ratio of leguminous protein source to casein source of 50/50 to 85/15, in particular 60/40 to 80/20.

In particular, the amounts of water, of leguminous protein source and of casein source in the composition may be adjusted so as to obtain a composition comprising 10% to 20%, preferably 11 to 20%, 12 to 20%, 13 to 20%, 14 to 20%, even more preferably 15 to 20%, by weight of proteins based on the weight of the composition.

The leguminous protein source and the casein source may be mixed as dry powders and water may be added subsequently. Alternatively, the leguminous protein source and the casein source may be directly mixed into water. Common technology known in this field can be used like agitators, homogenization pumps or Homo mixer, Puddle mixer and Disperser.

Water will be selected from well-known sources adapted to food, feed or cosmetic applications. In particular, the water may be potable water, deionized water, decarbonated water or distilled water.

The process of the invention may further comprise a step of mixing the composition until full homogenization. In the context of the present invention, full homogenization may be reached when the composition is a uniform suspension, i.e. it does not comprise undissolved aggregates.

The process of the invention may further comprise a step of introducing the composition in a package. In particular, the package may be suited for direct administration to a consumer, for example a plastic cup, a plastic bottle, a plastic bag, a metal can or a paper bottle.

The process of the invention comprises a step of heat-sterilization. In general, heat sterilization can be carried out by heating the composition, for example at a temperature greater than 100° C., for a period of time sufficient to inhibit the enzymes and any form of microorganisms, in particular sporulating bacteria.

In a preferred embodiment, the heating step is carried out at a temperature comprised between 60° C. and 80° C., preferably 70° C., for a length comprised between 20 and 60 min, preferably between 30 and 50 min. Sterilization may also be carried out at high temperature, that is to say a temperature of 135° C. to 150° C., for a period usually not exceeding 15 seconds, in other words between 0.1 and 15 seconds, which corresponds to UHT (Ultra-High Temperature) sterilization. This technique has the advantage of preserving the nutritional and organoleptic properties of the sterilized product. The heat-sterilization step can be carried out by means of the devices and techniques known to those skilled in the art, such as a water bath, oil bath, UHT machine, direct steam injection system, retort machine or Joule heating.

The mixture is then subjected to a cooling step, preferably cooling at 4° C. for 12 hours.

According to the present invention, the heat-sterilization step is carried out on the mixture of pea protein and casein source. Without this heat-treatment step, the suspension of pea and casein source will stay in a liquid suspension state, without reaching the desired soft gel texture, with desired hardness. No examples can be shown to exemplify the mixture without heat-treatment because such liquid suspension samples cannot be analyzed with Texture Analyzer in order to assay its hardness The food formulation obtained by the process of the invention exhibits a low hardness, namely less than 0.2 N, despite the use of a heat-sterilization step.

The food formulation of the invention is particularly suitable for a person in need of proteins, more particularly in need of arginine. The food composition of the present invention may therefore be used in the preparation of a food formulation, such as a specialized nutrition composition or a feed composition. Examples of specialized nutrition compositions include food for athletes, people doing light exercise, growing children and elderly people.

The food formulation can in particular be used to supply nutrition to people having problems with chewing and swallowing, for example dysphasia. These people cannot eat hard texture food such as meat and beans, regardless of their age. Therefore, the food composition of the invention will help them obtain sufficient proteins in their diet.

### Test Methods

### Measurement of Hardness: Test A

The hardness of a composition is measured with a Texture Analyzer, such as SHIMAZU EZ-SX equipped with tooth shape chip, according to the following protocol:
1. 85 g of food composition are introduced in a plastic bag (3 cm diameter, 35 cm length)
2. Plastic bag is heated at 70° C. during 40 min and cooled at 4° C. for 12 h
3. Plastic bag is opened and food composition is taken out
4. Samples with 2 cm thickness are cut
5. Sample is placed on a metal dish, and put on the stage of the texture analyzer. Tooth type chip is used as the probe of the texture analyzer, and the probe is stuck on the side of the cylinder shape gel, and brought down until the probe reaches the bottom of the metal dish (speed 1 mm/sec)
6. Analysis is carried out and maximum peak hardness in measured in Newton (N).

The invention will be better understood with the non-limitative examples below.

### EXAMPLES

The following ingredients are used in the examples:
Pea protein isolate (PPI—78% wt protein): NUTRALYS S85F (from ROQUETTE)
Milk Protein Concentrate (MPC—76% wt protein): MPC480 (from FONTERRA)
Whey Protein Concentrate (WPC—80% wt protein): WPC392 (from FONTERRA)
Sodium Caseinate (SC—92% wt protein): TATUA 100 (from TATUA)
Calcium Caseinate (CC—92% wt protein): TATUA 200 (from TATUA)
Magnesium Caseinate (MC—91% wt protein): TATUA 600 (from TATUA)
Soy Protein Isolate (SPI—85% wt protein): SOLPEE 4000H (from Nisshin-oillio)
Maltodextrin: Glucidex® 19 (from ROQUETTE)
Sunflower oil (from Showa-sangyo)

All examples share the same protocol in order to generate a sample:
1. Weigh all powders and water
2. Place and mix them in a 400 ml beaker under magnetic stirring until homogenization
3. Introduce 85 g of the composition in a plastic package (3 cm diameter and 35 cm length)
4. Heat at 70° C. during 40 min
5. Cool at 4° C. for 12 h

The type and amount (in grams) of each ingredient is indicated in the Tables below. The hardness of each sample is measured according to Test A described above.

Steps 3 to 5 are the same as steps 1 and 2 of Test A and do not need to be repeated.

### Example 1: Influence of Protein Source Selection at 20% Protein Content

In this example, compositions comprising 20% by weight of proteins based on the weight of the composition were prepared with different protein sources following the procedure described above. The weight of each ingredient is indicated in grams (g) in the tables below. The weight ratio between the protein sources is also indicated in the tables below. The hardness of each composition in Newtons (N) was measured according to Test A described above.

TABLE 1
Mixture of pea protein isolate (PPI) and Milk protein concentrate (MPC) according to the invention

| PPI/MPC | #1 | #2 | #3 | #4 | #5 | #6 | #7 | #8 | #9 | #10 | #11 |
|---|---|---|---|---|---|---|---|---|---|---|---|
| Water | 135 | 134.5 | 134.5 | 135 | 134.5 | 134 | 134.5 | 134.5 | 134 | 134.5 | 134 |
| PPI | 65 | 61.5 | 58.5 | 55 | 52 | 49 | 45.5 | 42 | 39 | 35.5 | 32.5 |
| MPC | 0 | 4 | 7 | 10 | 13.5 | 17 | 20 | 23.5 | 27 | 30 | 33.5 |
| Glucidex 19 | 48 | 48 | 48 | 48 | 48 | 48 | 48 | 48 | 48 | 48 | 48 |
| NaCl | 0.6 | 0.6 | 0.6 | 0.6 | 0.6 | 0.6 | 0.6 | 0.6 | 0.6 | 0.6 | 0.6 |
| Sunflower oil | 7.2 | 7.2 | 7.2 | 7.2 | 7.2 | 7.2 | 7.2 | 7.2 | 7.2 | 7.2 | 7.2 |
| PPI ratio (%) | 100 | 95 | 90 | 85 | 80 | 75 | 70 | 65 | 60 | 55 | 50 |
| MPC ratio (%) | 0 | 5 | 10 | 15 | 20 | 25 | 30 | 35 | 40 | 45 | 50 |
| Hardness (N) | 0.63 | 0.41 | 0.24 | 0.11 | 0.04 | 0.02 | 0.03 | 0.03 | 0.04 | 0.09 | 0.14 |
| SD | 0.019 | 0.016 | 0.046 | 0.003 | 0.019 | 0.004 | 0.004 | 0.014 | 0.032 | 0.01 | 0.01 |

| PPI/MPC | #12 | #13 | #14 | #15 | #16 | #17 | #18 | #19 | #20 | #21 |
|---|---|---|---|---|---|---|---|---|---|---|
| Water | 134 | 134 | 134 | 133.5 | 134 | 133.5 | 133 | 133.5 | 133 | 133 |
| PPI | 29 | 26 | 22.5 | 19.5 | 16 | 13 | 10 | 6.5 | 3.5 | 0 |
| MPC | 37 | 40 | 43.5 | 47 | 50 | 53.5 | 57 | 60 | 63.5 | 67 |
| Maltodextrin | 48 | 48 | 48 | 48 | 48 | 48 | 48 | 48 | 48 | 48 |
| NaCl | 0.6 | 0.6 | 0.6 | 0.6 | 0.6 | 0.6 | 0.6 | 0.6 | 0.6 | 0.6 |
| Sunflower oil | 7.2 | 7.2 | 7.2 | 7.2 | 7.2 | 7.2 | 7.2 | 7.2 | 7.2 | 7.2 |
| PPI ratio (%) | 45 | 40 | 35 | 30 | 25 | 20 | 15 | 10 | 5 | 0 |
| MPC ratio (%) | 55 | 60 | 65 | 70 | 75 | 80 | 85 | 90 | 95 | 100 |
| Hardness (N) | 0.14 | 0.19 | 0.14 | 0.18 | 0.17 | 0.21 | 0.27 | 0.23 | 0.28 | 0.24 |
| SD | 0.024 | 0.021 | 0.031 | 0.095 | 0.005 | 0.007 | 0.008 | 0.043 | 0.052 | 0.067 |

TABLE 2
Mixture of pea protein isolate (PPI) and Soy protein concentrate (SPC) not according to the invention

| PPI/SPC | #1 | #2 | #3 | #4 | #5 | #6 | #7 | #8 | #9 | #10 | #11 |
|---|---|---|---|---|---|---|---|---|---|---|---|
| Water | 135 | 135 | 135.5 | 136 | 136 | 136 | 136.5 | 136.5 | 137 | 137 | 136 |
| PPI | 65 | 61.5 | 58.5 | 55 | 52 | 49 | 45.5 | 42 | 39 | 35.5 | 32.5 |
| SPC | 0 | 3.5 | 6 | 9 | 12 | 15 | 18 | 21.5 | 24 | 27.5 | 31.5 |
| Maltodextrin | 48 | 48 | 48 | 48 | 48 | 48 | 48 | 48 | 48 | 48 | 48 |
| NaCl | 0.6 | 0.6 | 0.6 | 0.6 | 0.6 | 0.6 | 0.6 | 0.6 | 0.6 | 0.6 | 0.6 |
| Sunflower oil | 7.2 | 7.2 | 7.2 | 7.2 | 7.2 | 7.2 | 7.2 | 7.2 | 7.2 | 7.2 | 7.2 |
| PPI ratio (%) | 100 | 95 | 90 | 85 | 80 | 75 | 70 | 65 | 60 | 55 | 50 |
| SPC ratio (%) | 0 | 5 | 10 | 15 | 20 | 25 | 30 | 35 | 40 | 45 | 50 |
| Hardness (N) | 0.69 | 0.78 | 0.86 | 0.86 | 0.90 | 0.85 | 1.04 | 1.24 | 1.30 | 1.47 | 1.82 |
| SD | 0.048 | 0.234 | 0.13 | 0.02 | 0.012 | 0.192 | 0.158 | 0.234 | 0.208 | 0.016 | 0.551 |

| PPI/SPC | #12 | #13 | #14 | #15 | #16 | #17 | #18 | #19 | #20 | #21 |
|---|---|---|---|---|---|---|---|---|---|---|
| Water | 137.5 | 137.5 | 138 | 138 | 138.5 | 138.5 | 138.5 | 139 | 139 | 139.5 |
| PPI | 29 | 26 | 22.5 | 19.5 | 16 | 13 | 10 | 6.5 | 3.5 | 0 |
| SPC | 33.5 | 36.5 | 39.5 | 42.5 | 45.5 | 48.5 | 51.5 | 54.5 | 57.5 | 60.5 |
| Maltodextrin | 48 | 48 | 48 | 48 | 48 | 48 | 48 | 48 | 48 | 48 |
| NaCl | 0.6 | 0.6 | 0.6 | 0.6 | 0.6 | 0.6 | 0.6 | 0.6 | 0.6 | 0.6 |
| Sunflower oil | 7.2 | 7.2 | 7.2 | 7.2 | 7.2 | 7.2 | 7.2 | 7.2 | 7.2 | 7.2 |
| PPI ratio (%) | 45 | 40 | 35 | 30 | 25 | 20 | 15 | 10 | 5 | 0 |
| SPC ratio (%) | 55 | 60 | 65 | 70 | 75 | 80 | 85 | 90 | 95 | 100 |
| Hardness (N) | 1.82 | 1.77 | 1.61 | 2.11 | 2.36 | 2.48 | 2.61 | 2.58 | 2.99 | 3.20 |
| SD | 0.259 | 0.366 | 0.080 | 0.376 | 0.656 | 0.553 | 0.642 | 0.303 | 0.629 | 0.584 |

TABLE 3
Mixture of soy protein isolate (SPI) and Milk protein
concentrate (MPC) not according to the invention

| SPI/MPC | #1 | #2 | #3 | #4 | #5 | #6 |
|---|---|---|---|---|---|---|
| Water | 133 | 134.5 | 136 | 136.5 | 138 | 139.5 |
| MPC | 67 | 53.5 | 40 | 27 | 13.5 | 0 |
| SPI | 0 | 12 | 24 | 36.5 | 48.5 | 60.5 |
| Maltodextrin | 48 | 48 | 48 | 48 | 48 | 48 |
| NaCl | 0.6 | 0.6 | 0.6 | 0.6 | 0.6 | 0.6 |
| Sunflower oil | 7.2 | 7.2 | 7.2 | 7.2 | 7.2 | 7.2 |
| MPC ratio (%) | 100 | 80 | 60 | 40 | 20 | 0 |
| SPI ratio (%) | 0 | 20 | 40 | 60 | 80 | 100 |
| Hardness (N) | 0.31 | 0.27 | 0.21 | 0.38 | 0.92 | 3.14 |
| SD | 0.065 | 0.027 | 0.007 | 0.031 | 0.417 | 0.118 |

TABLE 4
Mixture of pea protein isolate (PPI) and Whey protein
isolate (WPI) not according to the invention

| PPI/WPI | #1 | #2 | #3 | #4 | #5 | #6 | #7 | #8 |
|---|---|---|---|---|---|---|---|---|
| Water | 135 | 135 | 135 | 135.5 | 135 | 135.5 | 135.5 | 135.5 |
| PPI | 65 | 61.5 | 58.5 | 55 | 52 | 45.5 | 39 | 35.5 |
| WPI | 0 | 3.5 | 6.5 | 9.5 | 13 | 19 | 25.5 | 29 |
| Maltodextrin | 48 | 48 | 48 | 48 | 48 | 48 | 48 | 48 |
| NaCl | 0.6 | 0.6 | 0.6 | 0.6 | 0.6 | 0.6 | 0.6 | 0.6 |
| Sunflower oil | 7.2 | 7.2 | 7.2 | 7.2 | 7.2 | 7.2 | 7.2 | 7.2 |
| PPI ratio (%) | 100 | 95 | 90 | 85 | 80 | 70 | 60 | 55 |
| WPI ratio (%) | 0 | 5 | 10 | 15 | 20 | 30 | 40 | 45 |
| Hardness (N) | 0.57 | 0.42 | 0.35 | 0.47 | 0.27 | 0.26 | 0.25 | 0.32 |
| SD | 0.121 | 0.063 | 0.039 | 0.056 | 0.072 | 0.073 | 0.028 | 0.007 |

| PPI/WPI | #9 | #10 | #11 | #12 | #13 | #14 | #15 |
|---|---|---|---|---|---|---|---|
| Water | 135.5 | 135.5 | 135.5 | 135.5 | 136 | 136 | 136 |
| PPI | 32.5 | 29 | 26 | 19.5 | 13 | 6.5 | 0 |
| WPI | 32 | 35.5 | 38.5 | 45 | 51 | 57.5 | 64 |
| Maltodextrin | 48 | 48 | 48 | 48 | 48 | 48 | 48 |
| NaCl | 0.6 | 0.6 | 0.6 | 0.6 | 0.6 | 0.6 | 0.6 |
| Sunflower oil | 7.2 | 7.2 | 7.2 | 7.2 | 7.2 | 7.2 | 7.2 |
| PPI ratio (%) | 50 | 45 | 40 | 30 | 20 | 10 | 0 |
| WPI ratio (%) | 50 | 55 | 60 | 70 | 80 | 90 | 100 |
| Hardness (N) | 0.31 | 0.41 | 0.39 | 0.77 | 1.06 | 1.52 | 1.92 |
| SD | 0.059 | 0.111 | 0.081 | 0.126 | 0.330 | 0.049 | 0.392 |

TABLE 5
Mixture of pea protein isolate (PPI) and Calcium Caseinate (CC) according to the invention

| PPI/CC | #1 | #2 | #3 | #4 | #5 | #6 | #7 | #8 | #9 | #10 | #11 |
|---|---|---|---|---|---|---|---|---|---|---|---|
| Water | 135 | 136 | 137 | 138 | 139 | 139.5 | 140.5 | 141.5 | 142.5 | 143.5 | 144.5 |
| PPI | 65 | 58.5 | 52 | 45.5 | 39 | 32.5 | 26 | 19.5 | 13 | 6.5 | 0 |
| CC | 0 | 5.5 | 11 | 16.5 | 22 | 28 | 33.5 | 39 | 44.5 | 50 | 55.5 |
| Maltodextrin | 48 | 48 | 48 | 48 | 48 | 48 | 48 | 48 | 48 | 48 | 48 |
| NaCl | 0.6 | 0.6 | 0.6 | 0.6 | 0.6 | 0.6 | 0.6 | 0.6 | 0.6 | 0.6 | 0.6 |
| Sunflower oil | 7.2 | 7.2 | 7.2 | 7.2 | 7.2 | 7.2 | 7.2 | 7.2 | 7.2 | 7.2 | 7.2 |
| CC ratio (%) | 0 | 10 | 20 | 30 | 40 | 50 | 60 | 70 | 80 | 90 | 100 |
| PPI ratio (%) | 100 | 90 | 80 | 70 | 60 | 500 | 40 | 30 | 20 | 10 | 0 |
| Hardness (N) | 0.57 | 0.10 | 0.05 | 0.06 | 0.07 | 0.46 | 1.10 | 1.22 | 1.02 | 0.90 | 0.86 |
| SD | 0.121 | 0.027 | 0.038 | 0.044 | 0.065 | 0.079 | 0.364 | 0.075 | 0.150 | 0.055 | 0.422 |

TABLE 6
Mixture of pea protein isolate (PPI) and Magnesium
Caseinate (MC) according to the invention

| PPI/MC | #1 | #2 | #3 | #4 | #5 | #6 |
|---|---|---|---|---|---|---|
| Water | 135 | 136.5 | 138.5 | 140.5 | 142 | 144 |
| PPI | 65 | 52 | 39 | 26 | 13 | 0 |
| MC | 0 | 11.5 | 22.5 | 33.5 | 45 | 56 |
| Maltodextrin | 48 | 48 | 48 | 48 | 48 | 48 |
| NaCl | 0.6 | 0.6 | 0.6 | 0.6 | 0.6 | 0.6 |
| Sunflower oil | 7.2 | 7.2 | 7.2 | 7.2 | 7.2 | 7.2 |
| MC ratio (%) | 0 | 20 | 40 | 60 | 80 | 100 |
| PPI ratio (%) | 100 | 80 | 60 | 40 | 20 | 0 |
| Hardness (N) | 0.60 | 0.03 | 0.69 | 2.72 | 1.49 | 2.92 |
| SD | 0.149 | 0.011 | 0.271 | 0.275 | 1.018 | 1.919 |

TABLE 7
Mixture of pea protein isolate (PPI) and Sodium Caseinate (SC) according to the invention

| PPI/SC | #1 | #2 | #3 | #4 | #5 | #6 | #7 | #8 | #9 | #10 | #11 | #12 |
|---|---|---|---|---|---|---|---|---|---|---|---|---|
| Water | 135 | 135.5 | 136 | 137 | 138 | 139 | 140 | 141 | 141.5 | 142.5 | 143.5 | 144.5 |
| PPI | 65 | 61.5 | 58.5 | 52 | 45.5 | 39 | 32.5 | 26 | 19.5 | 13 | 6.5 | 0 |
| SC | 0 | 3 | 5.5 | 11 | 16.5 | 22 | 27.5 | 33 | 39 | 44.5 | 50 | 55.5 |
| Maltodextrin | 48 | 48 | 48 | 48 | 48 | 48 | 48 | 48 | 48 | 48 | 48 | 48 |
| NaCl | 0.6 | 0.6 | 0.6 | 0.6 | 0.6 | 0.6 | 0.6 | 0.6 | 0.6 | 0.6 | 0.6 | 0.6 |
| Sunflower oil | 7.2 | 7.2 | 7.2 | 7.2 | 7.2 | 7.2 | 7.2 | 7.2 | 7.2 | 7.2 | 7.2 | 7.2 |
| PPI ratio (%) | 100 | 95 | 90 | 80 | 70 | 60 | 50 | 40 | 30 | 20 | 10 | 0 |
| SC ratio (%) | 0 | 5 | 10 | 20 | 30 | 40 | 50 | 60 | 70 | 80 | 90 | 100 |
| Hardness (N) | 0.57 | 0.47 | 0.36 | 0.14 | 0.10 | 0.29 | 0.73 | 1.02 | 1.98 | 2.94 | 3.09 | 3.16 |
| SD | 0.121 | 0.191 | 0.125 | 0.055 | 0.006 | 0.119 | 0.534 | 0.480 | 0.360 | 1.205 | 1.461 | 1.159 |

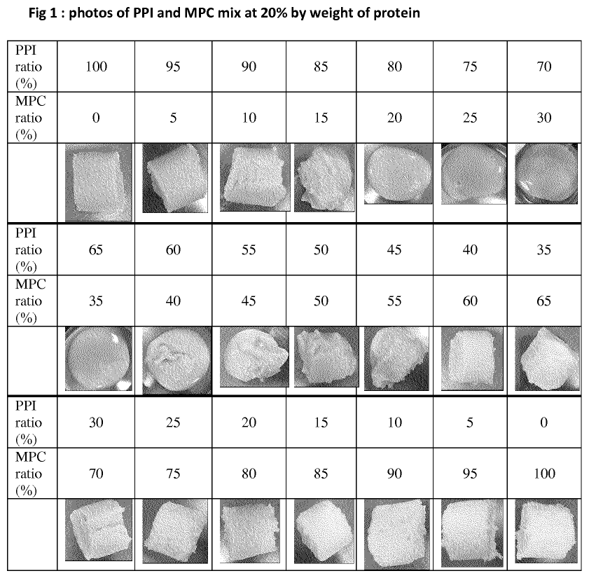

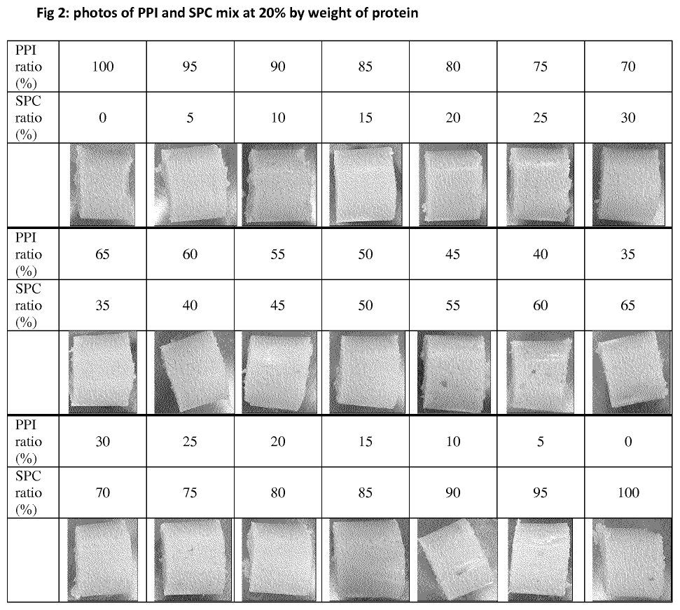

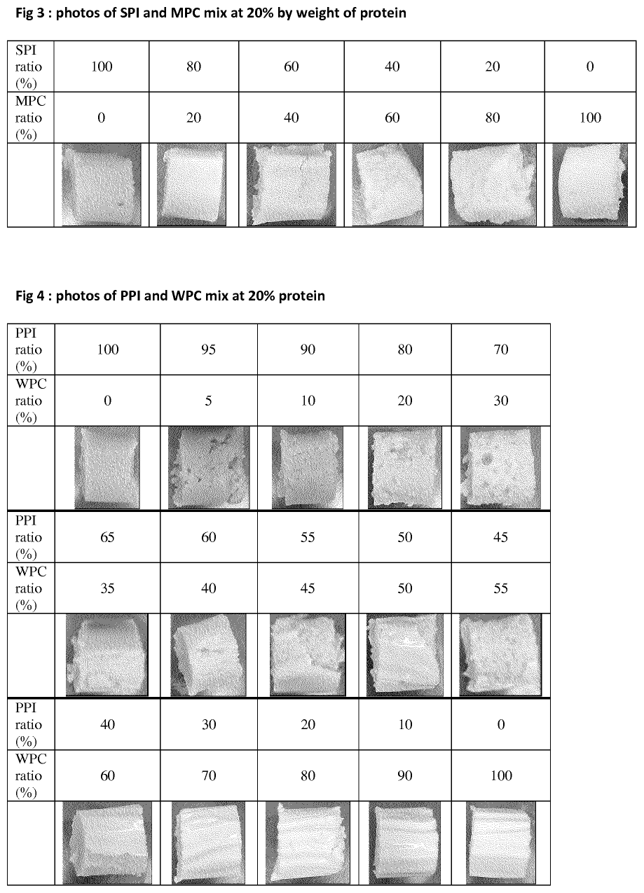

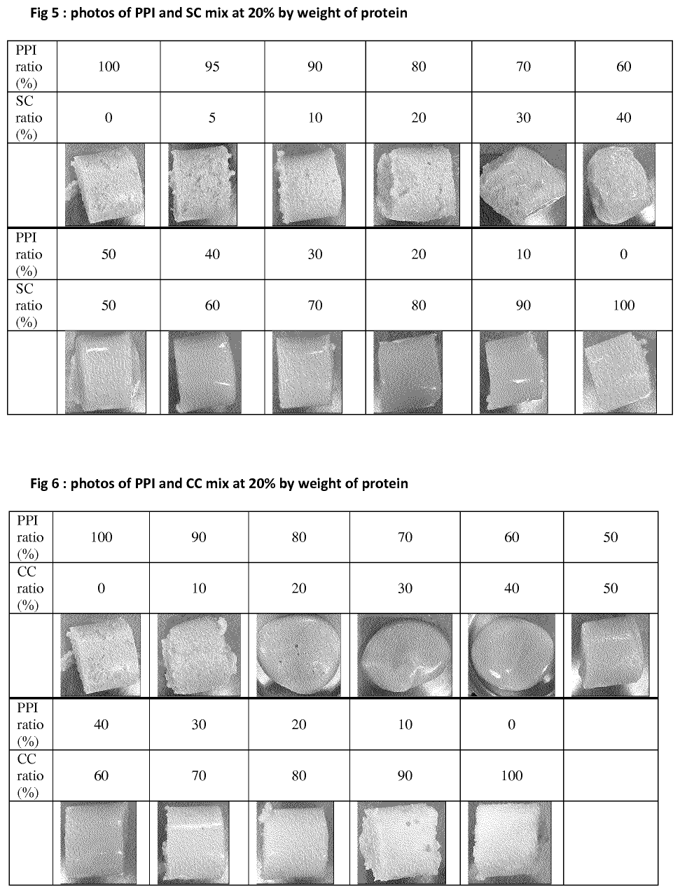

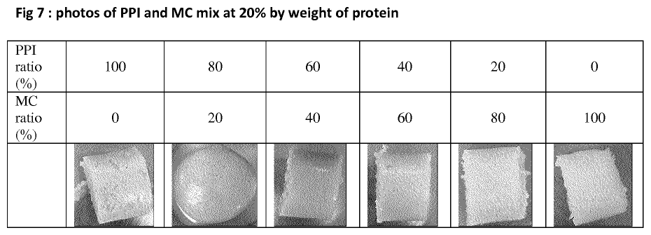

From the tables above, we can conclude that:
compositions comprising a mixture of a pea protein isolate and a casein source, e.g. a milk protein concentrate or magnesium caseinate, in a weight ratio of pea protein isolate to casein source of 50/50 to 85/15 can be used as a nutritional formulation with low hardness, namely below 0.2N, preferably between 0.1N and 0.2N;
FIGS. 1 to 7, which represent a photograph of each composition in Tables 1 to 7, show that the compositions according to the invention have a soft texture, close to liquid/gel state;
pea protein isolate alone, casein sources alone, or other plant protein isolates like soy lead to a food composition with a hardness above 0.2N after the heating step;
the combination of a pea protein isolate with a casein source in a weight ratio of 50/50 to 80/20 leads to a nutritional formulation comprising 0.69% to 1.12% by weight of arginin based on the weight of the composition.

### Example 2: Influence of Protein Content (Comparative)

In this example, compositions comprising a higher protein content (25% by weight) or a lower protein content (8% by weight) compared to that of Example 1 (20% by weight) were prepared following the procedure described above. The weight of each ingredient is indicated in grams (g) in the tables below. The weight ratio between the protein sources is also indicated in the tables below. The hardness of each composition in Newtons (N) was measured according to Test A described above.

TABLE 8
Composition comprising a mixture of pea protein isolate
(PPI) and milk protein concentrate (MPC) with 25% by weight
of protein based on the weight of the composition

| PPI/MPC | #1 | #2 | #3 | #4 | #5 |
|---|---|---|---|---|---|
| Water | 119 | 118 | 117.5 | 117 | 116 |
| PPI | 81 | 61 | 40.5 | 20 | 0 |
| MPC | 0 | 21 | 42 | 63 | 84 |
| Maltodextrin | 48 | 48 | 48 | 48 | 48 |
| NaCl | 0.6 | 0.6 | 0.6 | 0.6 | 0.6 |
| Sunflower oil | 7.2 | 7.2 | 7.2 | 7.2 | 7.2 |
| PPI ratio (%) | 100 | 75 | 50 | 25 | 0 |
| MPC ratio (%) | 0 | 25 | 50 | 75 | 100 |
| Hardness (N) | 5.5 | 5.2 | 8.5 | 7.8 | 8.3 |

TABLE 9
Composition comprising a mixture of pea protein isolate
(PPI) and milk protein concentrate (MPC) with 8% by weight
of protein based on the weight of the composition

| PPI/MPC | #1 | #2 | #3 | #4 | #5 |
|---|---|---|---|---|---|
| Water | 174 | 173.5 | 173.5 | 173.5 | 173 |
| PPI | 26 | 19.5 | 13 | 6.5 | 0 |
| MPC | 0 | 7 | 13.5 | 20 | 27 |
| Maltodextrin | 48 | 48 | 48 | 48 | 48 |
| NaCl | 0.6 | 0.6 | 0.6 | 0.6 | 0.6 |
| Sunflower oil | 7.2 | 7.2 | 7.2 | 7.2 | 7.2 |
| PPI ratio (%) | 100 | 75 | 50 | 25 | 0 |
| MPC ratio (%) | 0 | 25 | 50 | 75 | 100 |
| Hardness (N) | 0.035 | 0.035 | 0.034 | 0.034 | 0.035 |

Table 8 above shows that raising the protein content from 20% to 25% by weight of protein based on the weight of the composition leads to a high increase of hardness which results in food formulations that are not suited for the nutrition of specific consumers.

Table 9 above shows that compositions with a low protein content have a satisfying hardness but their protein content and arginine content is too low to be useful as nutritional formulations.

1. A food composition comprising 10% to 20%, preferably 15 to 20%, by weight of proteins based on the weight of the composition, wherein said food composition exhibits a hardness, as measured with Test A defined herein, of 0.01 to 0.2 N, preferably 0.1 to 0.2 N.

2. The food composition according to claim 1, wherein the composition comprises a mixture of a leguminous protein source and a casein source.

3. The food composition according to claim 2, wherein the leguminous protein source is selected from a pea protein isolate, a pea protein concentrate, a fava bean protein isolate, a fava bean protein concentrate, and mixtures thereof; in particular the leguminous protein source is a pea protein isolate.

4. The food composition according to claim 2, wherein the casein source is selected from a milk protein concentrate, sodium caseinate, calcium caseinate, magnesium caseinate, potassium caseinate, and mixtures thereof; in particular the casein source is a milk protein concentrate.

5. The food composition according to claim 2, wherein the weight ratio of the leguminous protein source to the casein source is 50/50 to 85/15, in particular 60/40 to 80/20.

6. The food composition according to claim 1, further comprising 0.4 to 1.4%, in particular 0.5 to 1.3%, more particularly 0.6 to 1.2%, by weight of arginine based on the weight of the composition.

7. A process for preparing a food composition as defined in claim 1, comprising the steps of:
providing a composition comprising water, a leguminous protein source, preferably a pea protein isolate, and a casein source, preferably a milk protein concentrate, in a weight ratio of leguminous protein source to casein source of 50/50 to 85/15, in particular 60/40 to 80/20;
optionally mixing the composition until full homogenization;
optionally introducing the composition in a package;
heat-sterilizing the composition; and
optionally, cooling the composition.

8. The process as claimed in claim 7, wherein the heat-sterilizing step is carried out at a temperature between 60° C. and 80° C., preferably 70° C., for a duration between 20 and 60 minutes, preferably between 30 and 50 minutes.

9. The process as claimed in claim 7, wherein the heat-sterilizing step is carried out at a temperature between 135° C. to 150° C., for a duration between 0.1 and 15 seconds.

10. A food formulation, comprising the food composition according to claim 1.

11. The food formulation according to claim 10, wherein said food formulation is a specialized nutritional composition.

12. The food formulation according to claim 10, wherein said food formulation is a feed composition.
